(19) United States
(12) Patent Application Publication
(10) Pub. No.: US 2020/0089852 A1
(43) Pub. Date: Mar. 19, 2020

(54) CONTROLLING ELECTRONIC ACCESS BY PORTABLE ELECTRONIC DEVICE RESPONSIVE TO SEQUENCE OF SCANNED FINGERPRINTS FORMING PIN

(71) Applicant: CA, Inc., New York, NY (US)

(72) Inventors: Sharath Bagivalu Manjappa, Hassan (IN); Anil Joseph, Bangalore (IN); Sharath Kumar, Bengaluru (IN); Stephen Prasad, Bengaluru (IN)

(73) Assignee: CA, Inc., New York, NY (US)

(21) Appl. No.: 16/133,876

(22) Filed: Sep. 18, 2018

(51) Int. Cl. G06F 21/32; H04L 9/32; G06K 9/00; G06F 3/041

(52) U.S. Cl. CPC G06F 21/32; H04L 9/3226; G06F 3/0416; G06K 9/0008; G06K 9/001

(57) ABSTRACT

A processor of an electronic device receives a personal identification number (PIN) having a sequence of numeric digits. For each digit of the PIN, a fingerprint scan is received from a fingerprint detector, and is registered as associated with the digit of the PIN. Subsequently, when a fingerprint scan matches the fingerprint scan that was registered for the digit of the PIN, the operations increment the PIN digit counter. In contrast, when the fingerprint scan does not match the fingerprint scan that was registered for the digit of the PIN, but does match the fingerprint scan that was registered for the next one of the PIN digits, the next PIN digit counter is incremented. When a PIN entry completion condition is satisfied, the operations selectively allow electronic access by a user to an application based on determining whether the sequence of PIN digit counters contain values matching the PIN.

### BACKGROUND

The present disclosure relates to electronic devices and, more particularly, to user interfaces for portable electronic devices.

Passwords remain the dominant approach for user authentication by computer systems because of their simplicity, legacy deployment and ease of revocation. Unfortunately, common approaches to entering passwords by way of keyboard, mouse, touch screen or any traditional input device, are vulnerable to attacks such as shoulder surfing and password snooping.

Shoulder-surfing is an attack on password authentication that has traditionally been hard to defeat. It can be done remotely using binoculars and cameras, using keyboard acoustics, or embedded keystroke tracking software. Access to the user's password simply by observing the user entering a password undermines the effort of encrypting passwords and protocols for authenticating the user securely. To some extent, the human actions when inputting the password are the weakest link in the chain.

Biometric authentication approaches, which identify individuals based on physiological characteristics, have the advantage that they are harder to replicate and therefore are not susceptible to the risks of shoulder surfing. However, biometric techniques suffer from the drawback that physiological characteristics are nonsecret and non-revocable. While it is easy for a user to change a password, it is perhaps not possible for the user to change a fingerprint.

### SUMMARY

Some embodiments of the present disclosure are directed to a method of performing operations on a processor of an electronic device. The operations include receiving a personal identification number (PIN) comprising a sequence of numeric digits. For each digit of the PIN, the operations receive from a fingerprint detector sensor a digital fingerprint scan of a finger, and register the digital fingerprint scan of the finger associated with the digit of the PIN. The operations later initialize a sequence of PIN digit counters, and set a PIN digit pointer to reference a first one of the PIN digit counters in the sequence. The operations receive from the fingerprint detector sensor a digital fingerprint scan of a finger. When the digital fingerprint scan matches the digital fingerprint scan that was registered for the digit of the PIN which corresponds to the PIN digit counter referenced by the PIN digit pointer, the operations increment the PIN digit counter referenced by the PIN digit pointer. In contrast, when the digital fingerprint scan does not match the digital fingerprint scan that was registered for the digit of the PIN which corresponds to the PIN digit counter referenced by the PIN digit pointer, but does match the digital fingerprint scan that was registered for the next one of the PIN digits in the sequence, the operations move the PIN digit pointer to reference the next one of the PIN digit counters in the sequence, and increment the next one of the PIN digit counters that is referenced by the PIN digit pointer. When a PIN entry completion condition is satisfied, the operations selectively allow electronic access by a user to an application processed by the processor of the electronic device based on determining whether the sequence of PIN digit counters contain values matching the PIN.

Corresponding operations by computer program products and electronic devices are disclosed. Other methods, computer program products, and electronic devices according to embodiments will be or become apparent to one with skill in the art upon review of the following drawings and detailed description. It is intended that all such additional methods, computer program products, and electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 illustrates an electronic device that authenticates a user who is operating the user terminal based on received fingerprint sequences according to some embodiments of the present disclosure;

FIG. 2 illustrates a fingerprint detection sensor configured according to some embodiments of the present disclosure;

FIG. 3 illustrates a flowchart of operations that may be performed by an electronic device to register digital fingerprint scans with digits of a personal identification number, according to some embodiments of the present disclosure;

FIGS. 4A-4E illustrate a sequence of display screens on an electronic device during registration of digital fingerprint scans with digits of a personal identification number, according to some embodiments of the present disclosure;

FIG. 5 illustrates a flowchart of operations that may be performed by an electronic device to selectively allow electronic access by a user to an application based on a sequence of digital fingerprint scans of the user's fingers, according to some embodiments of the present disclosure;

FIG. 6 illustrates a display screen on electronic device and a corresponding flowchart of operations performed by the electronic device to match a sequence of digital fingerprint scans to a personal identification number that is been registered for user, according to some embodiments of the present disclosure;

FIG. 7 illustrates a flowchart of operations that may be performed by an electronic device to modify a value of a PIN digit counter using a mathematical operator and/or offset value that is selected based on the rotation angle of the scanned fingerprint, according to some embodiments of the present disclosure; and

FIG. 8 is a block diagram of an electronic device configured according to some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As explained above, password entry remains a weakness in efforts to improve user authentication effectiveness. Some electronic devices authenticate users using digital fingerprint scans. One security weakness with this approach is that fingerprints are not secret, and can be easily observed and may be replicated to obtain unauthorized access to such electronic devices. Moreover, fingerprint authentication operations provide a single factor authentication, i.e., where the scanned fingerprint matches the registered fingerprint or it does not.

Various embodiments of the present disclosure are directed to providing improved fingerprint authentication operations that perform matching of digital fingerprint scans to registered digital fingerprints, in combination with matching a registered sequence of fingers that are scanned and a counted number of scans of each of the fingers in the sequence. These operations provide multi-factor authentication for fingerprint-based access control to electronic devices. The order of scanned fingers and the number of repetitive scans of each of the fingers in the sequence can be registered and stored in a data structure in a memory of the electronic device during a registration process, and maintained as a secret by the authentic user (e.g., registered owner of the electronic device and/or an application processed by the electronic device). Accordingly, replication of the fingerprint of the authentic user by a fraudster may satisfy one but not all the required multi-factor authentication operations, so the electronic device would prevent access to an application or other content of the electronic device.

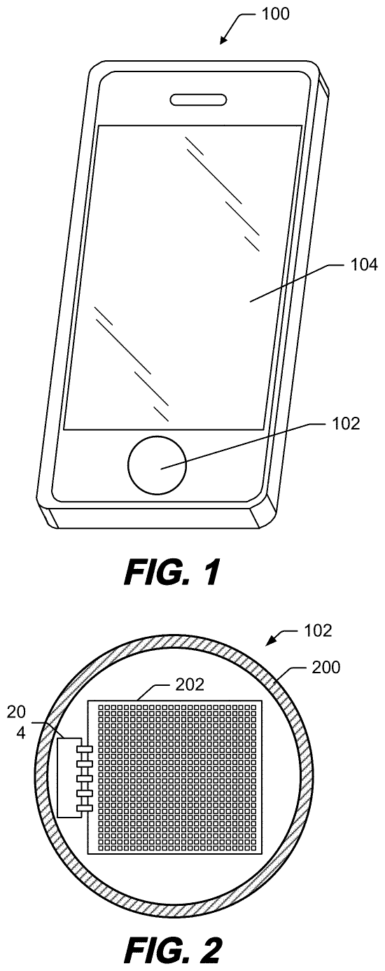

FIG. 1 illustrates an electronic device 100 that authenticates a user based on determining that a correct sequence of fingers and a number of scans of each finger in the sequence matches a personal identification number (PIN) that has been registered by a user, according to some embodiments of the present disclosure. Referring to FIG. 1, the electronic device 100 includes a display device 104 and a fingerprint detection sensor 102. The electronic device 100 can include, but is not limited to, a smartphone, a tablet computer, a media player, a personal computer, a gaming console, and/or another type of user operable device. The fingerprint detection sensor 102 is configured to electronically scan a user's fingerprint to output a digital fingerprint scan. A processor of electronic device receives a sequence of digital fingerprint scans from the fingerprint detector sensor 102, and selectively allows electronic access by the user to an application processed by the processor based on determining a combination of whether the digital fingerprint scans match a defined number of digital fingerprints stored in an authentication data structure residing in a memory and whether an order and number of the digital fingerprint scans in the sequence matches a registered order and number of the defined number of digital fingerprints.

FIG. 2 illustrates the fingerprint detection sensor 102 configured according to some embodiments of the present disclosure. Referring to FIG. 2, the fingerprint detection sensor 102 may include an array of capacitive sensor elements 202, an optical sensor, an infrared sensor, a thermal sensor, or other fingerprint imaging technology to output a multi-dimensional, e.g., 2 dimensional, digital representation of a user's fingerprint. In the illustrated embodiment, the capacitive sensor elements 202 are arranged in a 2 dimensional array and are each connected to coupling circuit 204, e.g., amplifier circuit and analog-to-digital converter, which outputs a digital fingerprint scan of a finger. The digital fingerprint scan is provided to a processor in the electronic device 100 for authentication of the user in accordance with one or more of the embodiments herein. In some embodiments, the sensor 102 includes a metal border, e.g., ring, 200 that can be supplied with a voltage to enhance capacitive coupling between the user's finger and the capacitive sensor elements 202 or may be grounded to shield the elements 202 from external electromagnetic interference.

The array of capacitive sensor elements 202 outputs a digital fingerprint scan of a user's finger. The scan can contain an array of capacitance values measured by the elements 202 based on capacitive coupling to the ridges and valleys of the epidermis layer of the finger which form a fingerprint. In some other embodiments, the array of capacitive sensor elements 202 is configured to capacitively couple to a subdermal layer of the user's finger, such as to the small blood vessels and tissue structure within the skin of the finger. The capacitance values from the capacitive sensor elements 202 contained in a digital fingerprint scan can be processed by the processor as a grayscale image of the fingerprint to identify features that are compared against a fingerprint that has been earlier registered by an authentic user in an authentication data structure stored in a memory of the electronic device 100 during a registration process for the electronic device 100 and/or an application processed by the electronic device 100.

A user is authenticated by the processor of the electronic device 100 based on whether the user scans different fingers a defined number of times with the fingerprint detector sensor 102 to generate digital fingerprint scans which match the registered fingerprint scans and corresponding repeated numbers that have been earlier registered in the authentication data structure. Thus, in some embodiments, the processor of the electronic device can be configured to selectively allow electronic access by a user to an application processed by the processor of the electronic device based on determining a combination of whether the digital fingerprint scans match a defined number of digital fingerprints stored in the authentication data structure and whether an order of the digital fingerprint scans in the sequence matches a registered order of the defined number of digital fingerprints.

Accordingly, a fraudster may be able to replicate the fingerprints of enough fingers of the authentic user for digital scanning by the sensor 102 to satisfy the authentication requirement that the digital fingerprint scans match registered fingerprint scans stored in the authentication data structure. However, the fraudster would not know the required order in which the fingerprints must be scanned and the number of times that each finger in the sequence must be scanned, since that is secret to the authentic user. The fraudster would therefore not be able to successfully complete authentication and would consequently be prevented from accessing content of the electronic device.

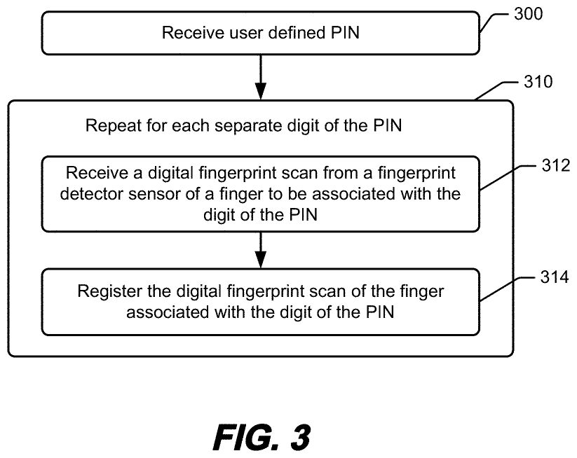

FIG. 3 illustrates a flowchart of operations that may be performed by an electronic device 100 to register digital fingerprint scans with digits of a personal identification number, according to some embodiments of the present disclosure. Referring to FIG. 3, the device 100 receives 300 a PIN comprising a sequence of numeric digits. For each digit of the PIN, the device 100 repeats operations 310 to receive 312 from the fingerprint detector sensor 102 a digital fingerprint scan of a finger, and to register 314 the digital fingerprint scan of the finger associated with the digit of the PIN. The registration operation can include storing information characterizing the digital fingerprint scan and a data structure with a defined association to the digit of the PIN.

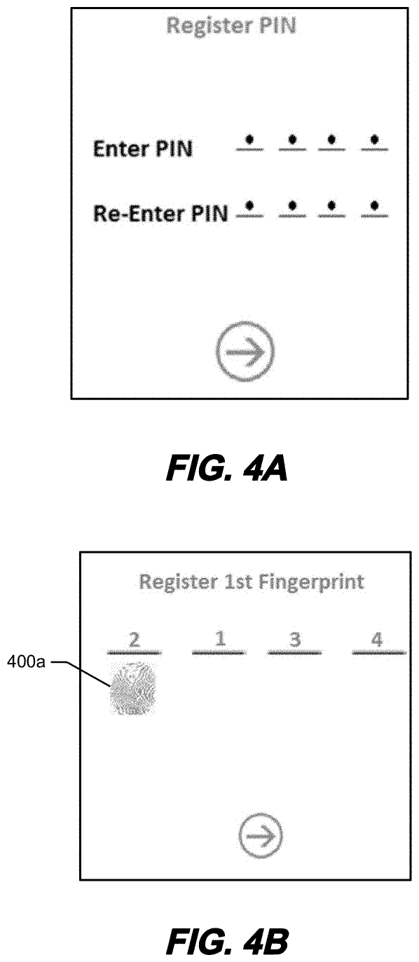

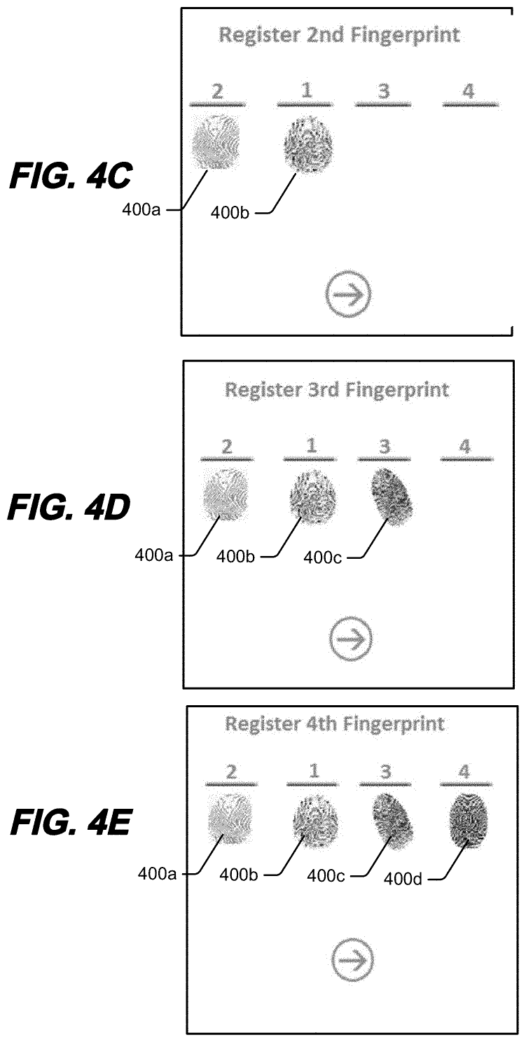

FIGS. 4A-4E illustrate a sequence of display screens on an electronic device 100 during registration of digital fingerprint scans with digits of a personal identification number, according to some embodiments of the present disclosure.

Referring to FIG. 4A, a user enters a 4 digit PIN which is hidden in FIG. 4A but shown as “2134” in FIGS. 4B-4E for ease of explanation. The entered PIN is stored in a data structure that is used for controlling electronic access to an application executed by the device 100 or another device, such as a computer server (e.g., an account server).

Referring to FIG. 4B, the user selects a finger 400a that will be registered as being associated with the first digit of the PIN, and then scans that finger for registration of information characterizing the digital fingerprint scan in the data structure with an association to the first digit of the PIN. As will be explained further below, to enter the first digit of the PIN the user will sequentially scan that selected finger two times corresponding to the “2” defined for the first digit of the PIN (i.e., touch the sensor 102 until a first scan is completed, then remove and again touch the sensor 102 until a second scan is completed).

Referring to FIG. 4C, the user selects another finger 400b that will be registered as being associated with the second digit of the PIN, and then scans that other finger for registration of information characterizing the digital fingerprint scan in the data structure with an association to the second digit of the PIN. As will be explained further below, to enter the second digit of the PIN the user will sequentially scan that selected finger one time1 corresponding to the “1” defined for the second digit of the PIN (i.e., touch the sensor 102 until a first scan is completed).

Referring to FIG. 4D, the user selects yet another finger 400c that will be registered as being associated with the third digit of the PIN, and then scans that another finger for registration of information characterizing the digital fingerprint scan in the data structure with an association to the third digit of the PIN. As will be explained further below, to enter the third digit of the PIN the user will sequentially scan that selected finger three times corresponding to the “3” defined for the third digit of the PIN (i.e., touch the sensor 102 until a first scan is completed, then remove and again touch the sensor 102 until a second scan is completed, and then remove and again touch the sensor 102 until a third scan is completed).

Referring to FIG. 4E, the user selects yet another finger 400d that will be registered as being associated with the fourth digit of the PIN, and then scans that another finger for registration of information characterizing the digital fingerprint scan in the data structure with an association to the fourth digit of the PIN. As will be explained further below, to enter the fourth digit of the PIN the user will sequentially scan that selected finger for times corresponding to the “4” defined for the fourth digit of the PIN (i.e., touch the sensor 102 until a first scan is completed, then remove and again touch the sensor 102 until a second scan is completed, then remove and again touch the sensor 102 until a third scan is completed, and then remove and again touch the sensor 102 until a fourth scan is completed).

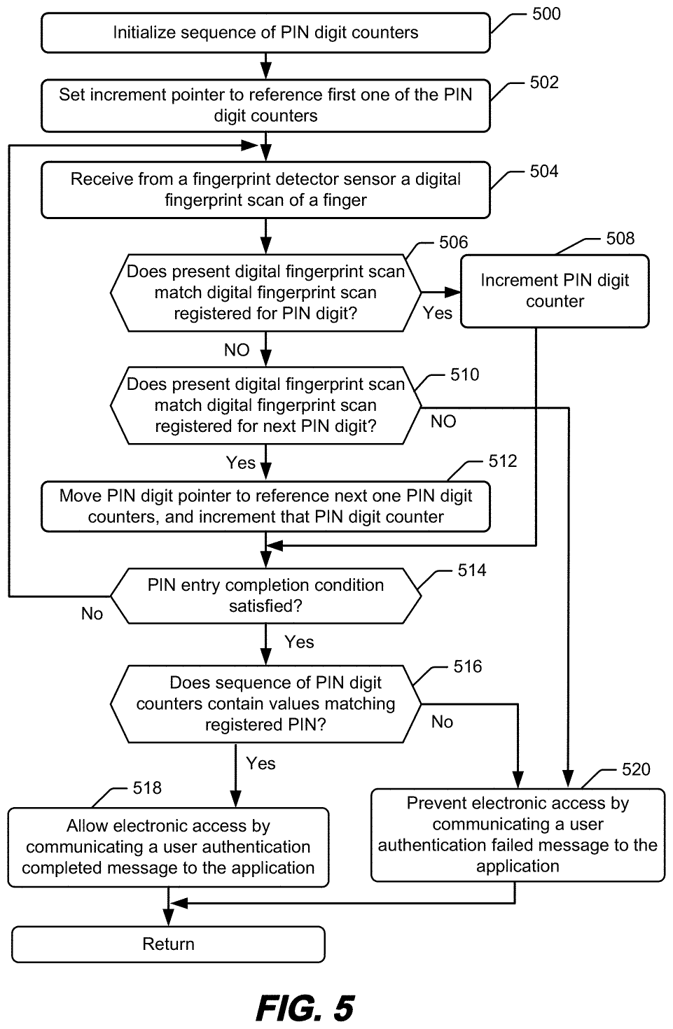

FIG. 5 illustrates a flowchart of operations that may be performed by an electronic device 100 to selectively allow electronic access by a user to an application based on a sequence of digital fingerprint scans of the user's fingers, according to some embodiments of the present disclosure.

Referring to FIG. 5, the operations initialize 500 a sequence of PIN digit counters, and set 502 a PIN digit pointer to reference a first one of the PIN digit counters in the sequence. The operations receive 506 from the fingerprint detector sensor 102 a digital fingerprint scan of a finger. When the digital fingerprint scan is determined to match 506 the digital fingerprint scan that was registered for the digit of the PIN which corresponds to the PIN digit counter referenced by the PIN digit pointer, the operations increment 508 the PIN digit counter referenced by the PIN digit pointer.

In contrast, when the digital fingerprint scan is determined 506 to not match the digital fingerprint scan that was registered for the digit of the PIN which corresponds to the PIN digit counter referenced by the PIN digit pointer, but is further determined 510 to match the digital fingerprint scan that was registered for the next one of the PIN digits in the sequence, the operations move 512 the PIN digit pointer to reference the next one of the PIN digit counters in the sequence, and increment the next one of the PIN digit counters that is referenced by the PIN digit pointer.

When a PIN entry completion condition is determined 514 to be satisfied, a determination 516 is made whether the sequence of PIN digit counters contain values matching the registered PIN. The operations selectively allow 518/520 electronic access by a user to an application processed by the processor of the electronic device based on determining whether the sequence of PIN digit counters contain values matching the PIN. For example, when a match is determined 516, the operations allow 518 electronic access by communicating a user authentication completed message to the application. In contrast, when a match is not determined 516, operations prevent 520 electronic access by communicating a user authentication failed message to the application.

In a further embodiment, when the PIN entry completion condition is satisfied 514, the operations allow electronic access by the user to the application processed by the processor of the electronic device based on determining that the sequence of PIN digit counters contain values matching the PIN, and prevent electronic access by the user to the application processed by the processor of the electronic device based on determining that the sequence of PIN digit counters does not contain values matching the PIN.

In a further embodiment, the operations to selectively allow electronic access include receiving, from a user through a user interface of the electronic device, a command to login to the application. The operations communicate a user authentication failed message to the application responsive to determining that the sequence of PIN digit counters contain values that do not match the PIN. In contrast, the operations communicate a user authentication completed message to the application responsive to determining that the sequence of PIN digit counters contain values matching the PIN.

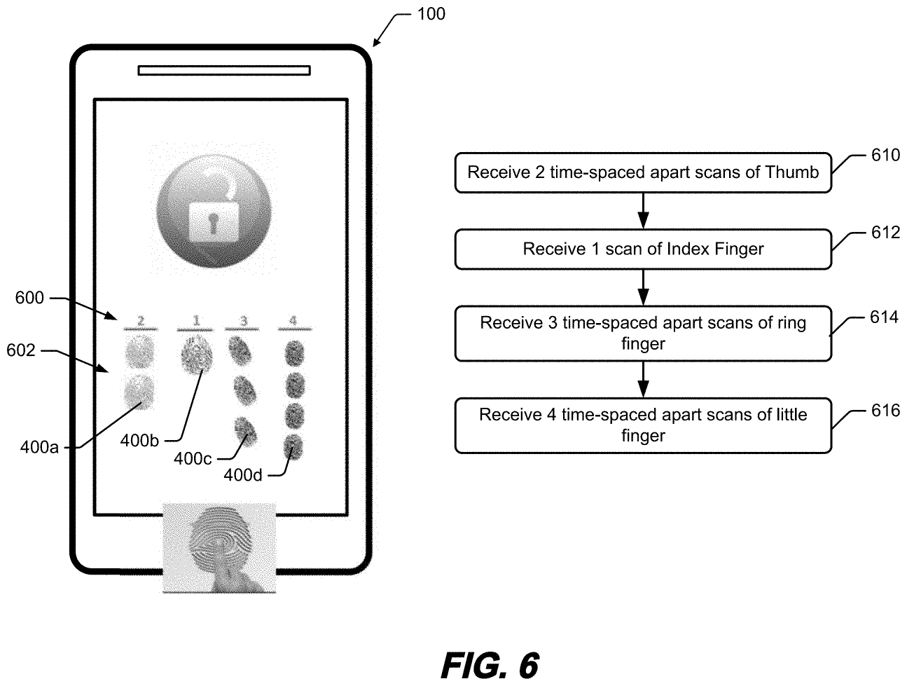

FIG. 6 illustrates a display screen on electronic device and a corresponding flowchart of operations performed by the electronic device to match a sequence of digital fingerprint scans to a personal identification number that is been registered for user, according to some embodiments of the present disclosure.

Referring to FIG. 6, the display screen of the device 100 may display the PIN 600 or the PIN may be something that is known but not displayed to the user. The user scans the sequence of fingers by sequentially touching the sensor 102. More particularly, to enter the registered PIN “2134” the user scans finger 400a twice, finger 400b once, finger 400c three times, and finger 400d four times.

Corresponding operations of the device 100 include receiving 610 two time-spaced apart scans of finger 400a (e.g., thumb), receiving 612 one scan of finger 400b (e.g., index finger), receiving 614 three time-spaced apart scans of finger 400c (e.g., ring finger), and receiving 616 four time-spaced apart scans of finger 400d (e.g., little finger).

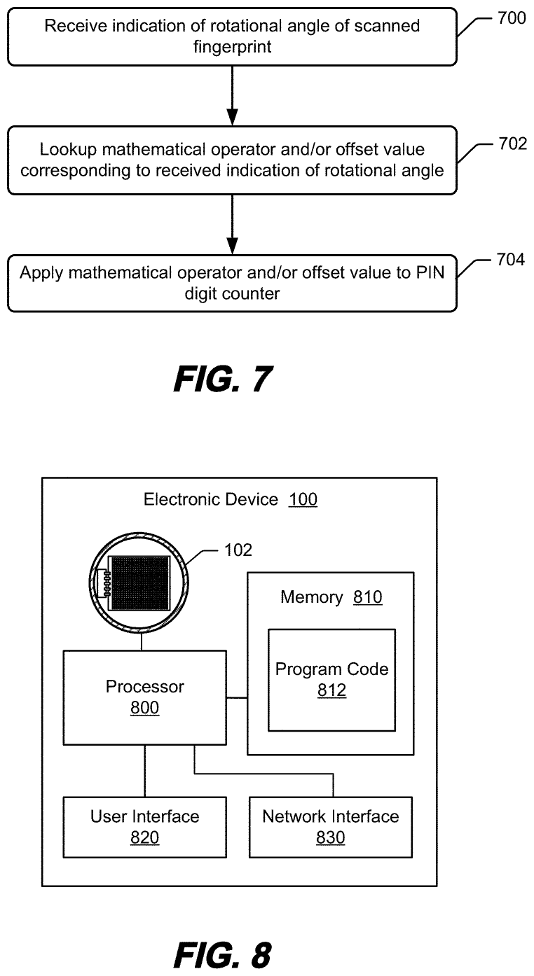

FIG. 7 illustrates a flowchart of operations that may be performed by an electronic device 100 to modify a value of a PIN digit counter using a mathematical operator and/or offset value that is selected based on the rotation angle of the scanned fingerprint, according to some embodiments of the present disclosure.

Referring to FIG. 7, when the digital fingerprint scan matches the digital fingerprint scan that was registered for the digit of the PIN which corresponds to the PIN digit counter referenced by the PIN digit pointer, the electronic device 100 can perform operations that receive 700 an indication of a rotational angle of the digital fingerprint scan. The device 100 can determine 702 an offset value corresponding to the rotational angle, and look up a mathematical operator and/or offset value the corresponds to the determined indication of rotational angle. The device 100 can then modify a value which is contained in the PIN digit counter referenced by the PIN digit pointer, responsive to the offset value.

For example, when the third finger 400c is scanned and determined to have an angle between 30 and 60 degrees relative to a longitudinal axis of the device 100, the operations may add an offset value of 2 or another defined value to the third PIN digit counter. In this manner, the device 100 for the user may define an offset value that can be selectively added to the PIN digit counter that is presently being incremented, which may be useful to allow the user to perform less finger scans in order to reach a higher value number corresponding to that digit of the PIN (e.g., to reach values 6-9).

The operations to determine the offset value corresponding to the rotational angle, can include selecting an offset value from among a set of offset values responsive to the rotational angle, where each of the offset values in the set is associated with a different defined range of rotational angles.

The operations to receive 700 from the fingerprint detector sensor 102 a digital fingerprint scan of a finger, can include receiving from the digital fingerprint scan an array of capacitance values measured by the array of capacitive sensor elements based on capacitive coupling to fingerprint ridges and valleys of a finger, and measuring a rotational angle between a pattern of the capacitance values in the array and a pattern of capacitance values that have been earlier registered for the digit of the PIN which corresponds to the PIN digit counter.

When the digital fingerprint scan matches the digital fingerprint scan that was registered for the digit of the PIN which corresponds to the PIN digit counter referenced by the PIN digit pointer, the electronic device 100 may perform operations that receive an indication of a rotational angle of the digital fingerprint scan. The operations can determine a mathematical operation corresponding to the rotational angle, and modify a value which contained in the PIN digit counter referenced by the PIN digit pointer, responsive to the mathematical operation.

The operations to determine the mathematical operation corresponding to the rotational angle, can include selecting the mathematical operator from among a set of mathematical operators responsive to the rotational angle, wherein each of the mathematical operators in the set is associated with a different defined range of rotational angles.

For example, when the fourth finger 400d is scanned and determined to have an angle between 30 and 60 degrees relative to a longitudinal axis of the device 100, the operations may select an mathematical operator of multiply by two, which is applied to multiply the value in the fourth PIN digit counter. In this manner, the user may scan finger 400d initially with an angle around 0 degrees and then rescan finger 400d with an angle between 30 and 60 degrees, so that the accumulated value 2 in the fourth PIN digit counter is multiplied by two which results in a PIN digit counter value of 4 corresponding to the fourth digit of the registered PIN. These operations may be useful to allow the user to perform less finger scans in order to reach a higher value number corresponding to that digit of the PIN (e.g., to reach values 6-9).

The operations to receive from the fingerprint detector sensor a digital fingerprint scan of a finger, can include receiving from the digital fingerprint scan an array of capacitance values measured by the array of capacitive sensor elements based on capacitive coupling to fingerprint ridges and valleys of a finger, and measuring a rotational angle between a pattern of the capacitance values in the array and a pattern of capacitance values that have been earlier registered for the digit of the PIN which corresponds to the PIN digit counter.

FIG. 8 is a block diagram of an electronic device 100 configured according to some embodiments of the present disclosure. Referring to FIG. 8, the electronic device 100 includes a fingerprint detector sensor 102, a processor 800, a memory 810, the user interface a 20, and a network interface 830. The fingerprint detector sensor 102 may be configured as shown in FIG. 2. The processor 800 may include one or more data processing circuits, such as a general purpose and/or special purpose processor (e.g., microprocessor and/or digital signal processor) that may be collocated within the electronic device 100 or distributed across one or more networks. The processor 800 is configured to execute computer program code 812 in the memory 810, described below as a non-transitory computer readable medium, to perform at least some of the operations described herein as being performed by an electronic device 100 or any component thereof. The user interface 820 may be a display device, a touch input interface on a display device, a keyboard, etc. The network interface 830 may be a wired network interface transceiver, e.g., Ethernet, and/or a wireless radiofrequency transceiver that is configured to operate according to one or more communication protocols, e.g., WiFi, Bluetooth, cellular LTE, etc.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on a processor of an electronic device:
receiving a personal identification number (PIN) comprising a sequence of numeric digits;
repeating for each digit of the PIN,
receiving from a fingerprint detector sensor a digital fingerprint scan of a finger, and
registering the digital fingerprint scan of the finger associated with the digit of the PIN;
initializing a sequence of PIN digit counters;
setting a PIN digit pointer to reference a first one of the PIN digit counters in the sequence;
receiving from the fingerprint detector sensor a digital fingerprint scan of a finger;
when the digital fingerprint scan matches the digital fingerprint scan that was registered for the digit of the PIN which corresponds to the PIN digit counter referenced by the PIN digit pointer, incrementing the PIN digit counter referenced by the PIN digit pointer;
when the digital fingerprint scan does not match the digital fingerprint scan that was registered for the digit of the PIN which corresponds to the PIN digit counter referenced by the PIN digit pointer, but does match the digital fingerprint scan that was registered for the next one of the PIN digits in the sequence, moving the PIN digit pointer to reference the next one of the PIN digit counters in the sequence, and incrementing the next one of the PIN digit counters that is referenced by the PIN digit pointer; and
when a PIN entry completion condition is satisfied, selectively allowing electronic access by a user to an application processed by the processor of the electronic device based on determining whether the sequence of PIN digit counters contain values matching the PIN.

2. The method of claim 1, further comprising:
when the PIN entry completion condition is satisfied,
allowing electronic access by the user to the application processed by the processor of the electronic device based on determining that the sequence of PIN digit counters contain values matching the PIN; and
preventing electronic access by the user to the application processed by the processor of the electronic device based on determining that the sequence of PIN digit counters does not contain values matching the PIN.

3. The method of claim 1, wherein the selectively allowing electronic access comprises:
receiving, from a user through a user interface of the electronic device, a command to login to the application;
communicating a user authentication failed message to the application responsive to determining that the sequence of PIN digit counters contain values that do not match the PIN; and
communicating a user authentication completed message to the application responsive to determining that the sequence of PIN digit counters contain values matching the PIN.

4. The method of claim 1, when the digital fingerprint scan matches the digital fingerprint scan that was registered for the digit of the PIN which corresponds to the PIN digit counter referenced by the PIN digit pointer, further comprising:
receiving an indication of a rotational angle of the digital fingerprint scan;
determining an offset value corresponding to the rotational angle; and
modifying a value which is contained in the PIN digit counter referenced by the PIN digit pointer, responsive to the offset value.

5. The method of claim 4, wherein determining the offset value corresponding to the rotational angle, comprises:
selecting an offset value from among a set of offset values responsive to the rotational angle, wherein each of the offset values in the set is associated with a different defined range of rotational angles.

6. The method of claim 4, wherein the receiving from the fingerprint detector sensor a digital fingerprint scan of a finger, comprises
receiving from the digital fingerprint scan an array of capacitance values measured by the array of capacitive sensor elements based on capacitive coupling to fingerprint ridges and valleys of a finger; and
measuring a rotational angle between a pattern of the capacitance values in the array and a pattern of capacitance values that have been earlier registered for the digit of the PIN which corresponds to the PIN digit counter.

7. The method of claim 1, when the digital fingerprint scan matches the digital fingerprint scan that was registered for the digit of the PIN which corresponds to the PIN digit counter referenced by the PIN digit pointer, further comprising:
receiving an indication of a rotational angle of the digital fingerprint scan;
determining a mathematical operation corresponding to the rotational angle; and
modifying a value which contained in the PIN digit counter referenced by the PIN digit pointer, responsive to the mathematical operation.

8. The method of claim 7, wherein determining the mathematical operation corresponding to the rotational angle, comprises:
selecting the mathematical operator from among a set of mathematical operators responsive to the rotational angle, wherein each of the mathematical operators in the set is associated with a different defined range of rotational angles.

9. The method of claim 7, wherein the receiving from the fingerprint detector sensor a digital fingerprint scan of a finger, comprises
receiving from the digital fingerprint scan an array of capacitance values measured by the array of capacitive sensor elements based on capacitive coupling to fingerprint ridges and valleys of a finger; and
measuring a rotational angle between a pattern of the capacitance values in the array and a pattern of capacitance values that have been earlier registered for the digit of the PIN which corresponds to the PIN digit counter.

10. A computer program product comprising:
a non-transitory computer readable medium storing program code that is executed by a processor of an electronic device to perform operations comprising:
receiving a personal identification number (PIN) comprising a sequence of numeric digits;
repeating for each digit of the PIN,
receiving from a fingerprint detector sensor a digital fingerprint scan of a finger, and
registering the digital fingerprint scan of the finger associated with the digit of the PIN;
initializing a sequence of PIN digit counters;
setting a PIN digit pointer to reference a first one of the PIN digit counters in the sequence;
receiving from the fingerprint detector sensor a digital fingerprint scan of a finger;
when the digital fingerprint scan matches the digital fingerprint scan that was registered for the digit of the PIN which corresponds to the PIN digit counter referenced by the PIN digit pointer, incrementing the PIN digit counter referenced by the PIN digit pointer;
when the digital fingerprint scan does not match the digital fingerprint scan that was registered for the digit of the PIN which corresponds to the PIN digit counter referenced by the PIN digit pointer, but does match the digital fingerprint scan that was registered for the next one of the PIN digits in the sequence, moving the PIN digit pointer to reference the next one of the PIN digit counters in the sequence, and incrementing the next one of the PIN digit counters that is referenced by the PIN digit pointer; and
when a PIN entry completion condition is satisfied, selectively allowing electronic access by a user to an application processed by the processor of the electronic device based on determining whether the sequence of PIN digit counters contain values matching the PIN.

11. The computer program product of claim 10, wherein the operations further comprise:
when the PIN entry completion condition is satisfied,
allowing electronic access by the user to the application processed by the processor of the electronic device based on determining that the sequence of PIN digit counters contain values matching the PIN; and
preventing electronic access by the user to the application processed by the processor of the electronic device based on determining that the sequence of PIN digit counters does not contain values matching the PIN.

12. The computer program product of claim 10, wherein the selectively allowing electronic access comprises:
receiving, from a user through a user interface of the electronic device, a command to login to the application;
communicating a user authentication failed message to the application responsive to determining that the sequence of PIN digit counters contain values that do not match the PIN; and
communicating a user authentication completed message to the application responsive to determining that the sequence of PIN digit counters contain values matching the PIN.

13. The computer program product of claim 10, when the digital fingerprint scan matches the digital fingerprint scan that was registered for the digit of the PIN which corresponds to the PIN digit counter referenced by the PIN digit pointer, further comprising:
receiving an indication of a rotational angle of the digital fingerprint scan;
determining an offset value corresponding to the rotational angle; and
modifying a value which contained in the PIN digit counter referenced by the PIN digit pointer, responsive to the offset value.

14. The computer program product of claim 13, wherein determining the offset value corresponding to the rotational angle, comprises:
selecting offset value from among a set of offset values responsive to the rotational angle, wherein each of the offset values in the set is associated with a different defined range of rotational angles.

15. The computer program product of claim 13, wherein the receiving from the fingerprint detector sensor a digital fingerprint scan of a finger, comprises
receiving from the digital fingerprint scan an array of capacitance values measured by the array of capacitive sensor elements based on capacitive coupling to fingerprint ridges and valleys of a finger; and
measuring a rotational angle between a pattern of the capacitance values in the array and a pattern of capacitance values that have been earlier registered for the digit of the PIN which corresponds to the PIN digit counter.

16. The computer program product of claim 10, when the digital fingerprint scan matches the digital fingerprint scan that was registered for the digit of the PIN which corresponds to the PIN digit counter referenced by the PIN digit pointer, further comprising:
receiving an indication of a rotational angle of the digital fingerprint scan;
determining a mathematical operation corresponding to the rotational angle; and
modifying a value which contained in the PIN digit counter referenced by the PIN digit pointer, responsive to the mathematical operation.

17. The computer program product of claim 16, wherein determining the mathematical operation corresponding to the rotational angle, comprises:
selecting the mathematical operator from among a set of mathematical operators responsive to the rotational angle, wherein each of the mathematical operators in the set is associated with a different defined range of rotational angles.

18. The computer program product of claim 16, wherein the receiving from the fingerprint detector sensor a digital fingerprint scan of a finger, comprises
receiving from the digital fingerprint scan an array of capacitance values measured by the array of capacitive sensor elements based on capacitive coupling to fingerprint ridges and valleys of a finger; and
measuring a rotational angle between a pattern of the capacitance values in the array and a pattern of capacitance values that have been earlier registered for the digit of the PIN which corresponds to the PIN digit counter.

19. An electronic device, comprising:
a fingerprint detector sensor;
a processor; and
a memory coupled to the processor and storing computer readable program code that when executed by the processor causes the processor to perform operations comprising:
receiving a personal identification number (PIN) comprising a sequence of numeric digits;
repeating for each digit of the PIN,
receiving from the fingerprint detector sensor a digital fingerprint scan of a finger, and
registering the digital fingerprint scan of the finger associated with the digit of the PIN;
initializing a sequence of PIN digit counters;
setting a PIN digit pointer to reference a first one of the PIN digit counters in the sequence;
receiving from the fingerprint detector sensor a digital fingerprint scan of a finger;
when the digital fingerprint scan matches the digital fingerprint scan that was registered for the digit of the PIN which corresponds to the PIN digit counter referenced by the PIN digit pointer, incrementing the PIN digit counter referenced by the PIN digit pointer;
when the digital fingerprint scan does not match the digital fingerprint scan that was registered for the digit of the PIN which corresponds to the PIN digit counter referenced by the PIN digit pointer, but does match the digital fingerprint scan that was registered for the next one of the PIN digits in the sequence, moving the PIN digit pointer to reference the next one of the PIN digit counters in the sequence, and incrementing the next one of the PIN digit counters that is referenced by the PIN digit pointer; and
when a PIN entry completion condition is satisfied, selectively allowing electronic access by a user to an application processed by the processor based on determining whether the sequence of PIN digit counters contain values matching the PIN.

20. The electronic device of claim 19, when the digital fingerprint scan matches the digital fingerprint scan that was registered for the digit of the PIN which corresponds to the PIN digit counter referenced by the PIN digit pointer, further comprising:
receiving from the fingerprint detector sensor an indication of a rotational angle of the digital fingerprint scan;
determining an offset value corresponding to the rotational angle; and
modifying a value which contained in the PIN digit counter referenced by the PIN digit pointer, responsive to the offset value.
